(19) United States
(12) Patent Application Publication
(10) Pub. No.: US 2020/0262590 A1
(43) Pub. Date: Aug. 20, 2020

(54) ATMOSPHERIC THRUST STAGES, MULTI-STAGE LAUNCH SYSTEMS INCLUDING THE SAME, AND RELATED METHODS

(71) Applicant: The Boeing Company, Chicago, IL (US)

(72) Inventor: Gregory James Gentry, League City, TX (US)

(21) Appl. No.: 16/280,857

(22) Filed: Feb. 20, 2019

(51) Int. Cl. B64G 1/64; B64G 1/62; B64G 1/00; B64G 1/26

(52) U.S. Cl. CPC B64G 1/641; B64G 1/26; B64G 1/002; B64G 1/62

(57) ABSTRACT

Atmospheric thrust stages, multi-stage launch systems including the same, and related methods. A multi-stage launch system includes a launch vehicle configured to transport a payload to a payload destination. The launch vehicle includes an atmospheric thrust stage (ATS) with a plurality of airbreathing engines configured to provide thrust to the launch vehicle for a vertical launch of the launch vehicle The ATS is configured to be retrieved and reused subsequent to returning to Earth. A method of transporting a payload to a payload destination includes powering a launch vehicle that includes an ATS and a second stage by providing thrust with a plurality of airbreathing engines of the ATS to propel the launch vehicle, decoupling the second stage from the ATS, powering the second stage to transport the payload to the payload destination, and returning the ATS to Earth.

### FIELD

The present disclosure relates to atmospheric thrust stages, multi-stage launch systems including the same, and related methods.

### BACKGROUND

Launch systems for delivering payloads to payload destinations (such as outer space) typically rely upon rockets to propel the payloads to such payload destinations. Such rockets generally carry all the fuel needed to supply a rocket engine to produce thrust, such that the rocket is operable in environments with little or no oxygen or other atmosphere. Owing to the high expense of such rockets, recent years have seen the development of space launch vehicles that include booster rockets that may be recovered, refurbished, and subsequently reused following a launch. However, such booster rockets may themselves be prohibitively expensive to produce, fuel, refurbish, and/or maintain.

### SUMMARY

Atmospheric thrust stages, multi-stage launch systems including the same, and related methods are disclosed herein. A multi-stage launch system for transporting a payload to a payload destination includes a launch vehicle configured to transport the payload to the payload destination via a payload trajectory. The payload trajectory includes a launch portion and a subsequent second portion. The launch vehicle includes an atmospheric thrust stage (ATS) that includes a structural frame that supports a plurality of airbreathing engines configured to at least partially propel the launch vehicle during the launch portion of the payload trajectory. The ATS is configured to be utilized in conjunction with a second stage of the launch vehicle that is configured to transport the payload to the payload destination during the second portion of the payload trajectory. Each airbreathing engine of the plurality of airbreathing engines is configured to impart a thrust force to the ATS along a respective ATS thrust vector to propel the launch vehicle. The launch vehicle is configured such that the ATS and the second stage are selectively and operatively coupled to and decoupled from one another. The ATS is configured to travel along an ATS trajectory that includes a boost portion and a subsequent return portion, such that the boost portion is concurrent with the launch portion of the payload trajectory. The launch vehicle is configured to launch vertically such that each ATS thrust vector is directed vertically upward to initiate the launch portion of the payload trajectory. The ATS is configured to return to Earth in a controlled descent during the return portion and to be retrieved and reused subsequent to the return portion of the ATS trajectory.

A method of transporting a payload to a payload destination includes powering a launch vehicle that includes an ATS operatively coupled to a second stage to propel the launch vehicle through a launch portion of a payload trajectory of the payload; decoupling the second stage of the launch vehicle from the ATS of the launch vehicle; powering the second stage to propel the second stage through a second portion of the payload trajectory to transport the payload to the payload destination; and subsequent to the decoupling the second stage from the ATS, returning the ATS to Earth during a return portion of an ATS trajectory of the ATS. The powering the launch vehicle through the launch portion includes providing thrust to the launch vehicle with a plurality of airbreathing engines of the ATS.

### BRIEF DESCRIPTION OF THE DRAWINGS

FIG. 1 is a schematic top plan view representing examples of launch vehicles according to the present disclosure.

FIG. 2 is a schematic side elevation view representing examples of launch vehicles according to the present disclosure.

FIG. 3 is a schematic diagram representing an example of a multi-stage launch system according to the present disclosure.

FIG. 4 is a schematic diagram representing another example of a multi-stage launch system according to the present disclosure.

FIG. 5 is a top side perspective view representing an example of a launch vehicle according to the present disclosure.

FIG. 6 is a flowchart depicting methods of transporting a payload to a payload destination according to the present disclosure.

### DESCRIPTION

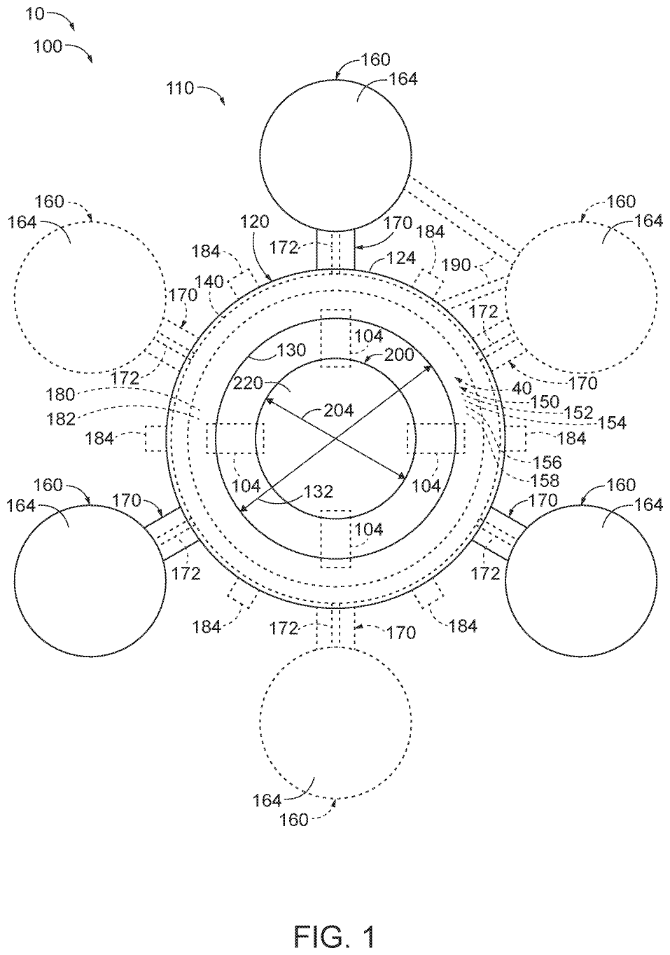

FIGS. 1-6 provide illustrative, non-exclusive examples of multi-stage launch systems 10 for transporting a payload 220 to a payload destination and/or of methods 300 of transporting a payload 220 to a payload destination, according to the present disclosure. Elements that serve a similar, or at least substantially similar, purpose are labeled with like numbers in each of FIGS. 1-6, and these elements may not be discussed in detail herein with reference to each of FIGS. 1-6. Similarly, all elements may not be labeled in each of FIGS. 1-6, but reference numerals associated therewith may be utilized herein for consistency. Elements, components, and/or features that are discussed herein with reference to one or more of FIGS. 1-6 may be included in and/or utilized with any of FIGS. 1-6 without departing from the scope of the present disclosure. Generally, in the figures, elements that are likely to be included in a given example are illustrated in solid lines, while elements that are optional to a given example are illustrated in dashed lines. However, elements that are illustrated in solid lines are not essential to all examples of the present disclosure, and an element shown in solid lines may be omitted from a given example without departing from the scope of the present disclosure.

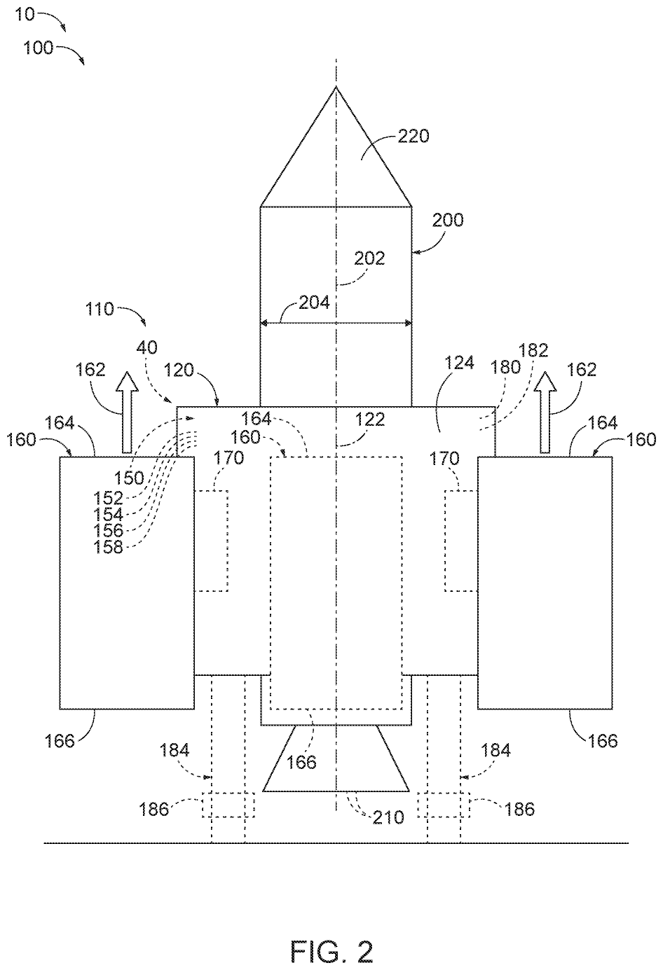

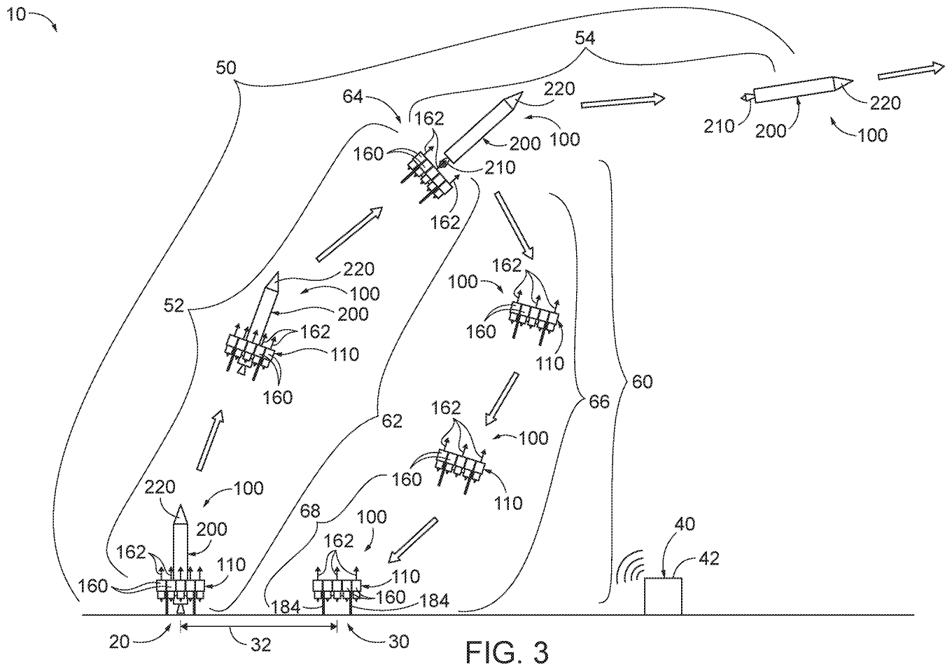

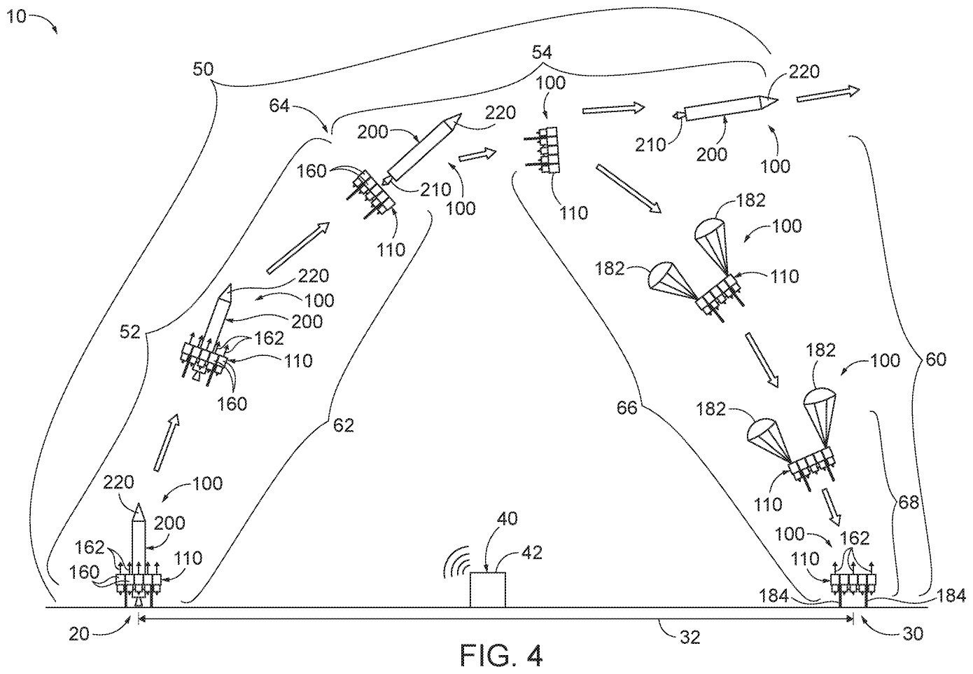

FIGS. 1-2 schematically illustrate examples of components of multi-stage launch systems 10 according to the present disclosure, while FIGS. 3-4 schematically illustrate operation of multi-stage launch systems 10. More specifically, FIGS. 1-2 schematically illustrate examples of launch vehicles 100 that may be utilized by multi-stage launch systems 10 according to the present disclosure, while FIGS. 3-4 schematically illustrate examples of trajectories and/or flight paths of such launch vehicles 100 during operation of multi-stage launch systems 10 according to the present disclosure.

As schematically illustrated in FIGS. 1-4, a multi-stage launch system 10 includes a launch vehicle 100 configured to transport a payload 220 to a payload destination via a payload trajectory 50 (shown in FIGS. 3-4). As schematically illustrated in FIGS. 3-4, and as described in more detail herein, payload trajectory 50 may be described as including a launch portion 52 that begins as launch vehicle 100 launches from a launch site 20 and a subsequent second portion 54 that begins at a staging point 64 of payload trajectory 50. More specifically, and as schematically illustrated in FIGS. 1-2, launch vehicle 100 includes an atmospheric thrust stage (ATS) 110 configured to at least partially propel launch vehicle 100 during launch portion 52 of payload trajectory 50, and additionally may include a second stage 200 configured to transport payload 220 to the payload destination during second portion 54 of payload trajectory 50. As further schematically illustrated in FIGS. 3-4, ATS 110 may be described as traveling along an ATS trajectory 60 that includes a boost portion 62 and a return portion 66 such that boost portion 62 is concurrent with launch portion 52.

As used herein, the term “payload destination” may refer to any appropriate position, location, altitude, and/or trajectory to which payload 220 is delivered. As an example, the payload destination may include and/or be a location in outer space. As more specific examples, the payload destination may include and/or be a sub-orbital trajectory, an Earth-centered orbit, a low-Earth orbit, a medium Earth orbit, a geosynchronous orbit, and/or a high Earth orbit. However, this is not required to all embodiments, and it is additionally within the scope of the present disclosure that the payload destination may include and/or be a location and/or trajectory within Earth's atmosphere.

The examples described herein generally correspond to embodiments in which launch vehicle 100 includes ATS 110 and second stage 200. However, this is not required to all embodiments, and it is additionally within the scope of the present disclosure that launch vehicle 100 may include and/or be ATS 110 alone. Stated differently, while the examples described herein generally pertain to embodiments in which launch vehicle 100 includes ATS 110 configured to be utilized in conjunction with second stage 200, the scope of the present disclosure also is intended to encompass launch vehicle 100 and/or ATS 110 with or without second stage 200.

As described in more detail herein, ATS 110 generally is configured to utilize airbreathing engines to provide a thrust to lift second stage 200 during launch portion 52 of payload trajectory 50. In this manner, ATS 110 delivers second stage 200 to an elevated altitude prior to second stage 200 propelling payload 220 to the payload destination under its own power. Thus, utilizing examples of launch vehicle 100 that include ATS 110 may enable delivering payload 220 to the payload destination more efficiently and/or at a lower expense.

As schematically illustrated in FIGS. 1-2, ATS 110 includes a structural frame 120 that supports a plurality of airbreathing engines 160 that are configured to generate a thrust to at least partially propel launch vehicle 100 during launch portion 52 of payload trajectory 50. More specifically, and as shown in FIGS. 2-4, each airbreathing engine 160 is configured to impart a thrust force to ATS 110 along a respective ATS thrust vector 162 to propel launch vehicle 100. As perhaps best illustrated in FIGS. 3-4, launch vehicle 100 generally is configured to launch vertically such that each ATS thrust vector 162 is directed vertically upward to initiate launch portion 52 of payload trajectory 50. As used herein, positional terms such as “vertical,” “vertically,” and the like may be used to describe spatial orientations of multi-stage launch systems 10, of launch vehicles 100, and/or of any components thereof in an illustrative, non-limiting manner, and generally refer to a direction that is parallel to a force of gravity and/or perpendicular to a level ground surface. For example, a direction that is described as “vertically upward” may refer to a direction that is antiparallel to the force of gravity.

Launch vehicles 100 according to the present disclosure generally are configured such that ATS 110 is reusable. Stated differently, ATS 110 may be described as and/or referred to as a reusable boost stage for delivering payload 220 to the payload destination. More specifically, launch vehicle 100 is configured such that ATS 110 and second stage 200 are selectively and operatively coupled to and decoupled from one another. In this manner, and as described herein, ATS 110 (e.g., a given ATS 110) may be configured to be reused with a plurality of distinct second stages 200 to form a plurality of distinct launch vehicles 100 for sequentially delivering a plurality of distinct payloads 220 to respective payload destinations.

As discussed, ATS 110 may be described as traveling along ATS trajectory 60 that includes boost portion 62 and return portion 66 such that boost portion 62 is concurrent with launch portion 52. Stated differently, launch portion 52 of payload trajectory 50 and boost portion 62 of ATS trajectory 60 generally correspond to the same portion of a trajectory and/or flight path of launch vehicle 100, such as a portion during which ATS 110 and second stage 200 are operatively coupled to one another. That is, and as schematically illustrated in FIGS. 3-4, ATS 110 and second stage 200 may be configured to be selectively decoupled from one another during payload trajectory 50, such as at staging point 64 at which payload trajectory 50 transitions from launch portion 52 to second portion 54. Stated differently, payload trajectory 50 transitioning from launch portion 52 to second portion 54 may correspond to and/or be defined by ATS 110 and second stage 200 selectively decoupling from one another. Stated another way, staging point 64 may correspond to a point at which payload trajectory 50 transitions from launch portion 52 to second portion 54, and/or a point at which ATS trajectory 60 transitions from boost portion 62 to return portion 66.

As used herein, staging point 64 may include and/or be any appropriate descriptor, such as a point in time and/or a location in space. Staging point 64 may occur and/or coincide with any appropriate point in payload trajectory 50 and/or in ATS trajectory 60. As an example, staging point 64 may be described as occurring at a staging altitude, such as may correspond to and/or be determined by an operational characteristic of ATS 110. For example, the staging altitude may correspond to a maximum altitude at which the plurality of airbreathing engines 160 may operate efficiently and/or reliably. As more specific examples, the staging altitude may be at least 5 kilometers (km), at least 10 km, at least 15 km, at least 20 km, at least 25 km, at least 30 km, at least 35 km, at most 40 km, at most 32 km, at most 27 km, at most 22 km, at most 17 km, at most 12 km, and/or at most 7 km.

As additionally schematically illustrated in FIGS. 3-4, return portion 66 of ATS trajectory 60 additionally may include a landing portion 68 during which ATS 110 lands at an ATS landing site 30. As further schematically illustrated in FIGS. 3-4, ATS 110 may be configured such that each ATS thrust vector 162 is directed at least substantially vertically upward during landing portion 68 of ATS trajectory 60. Stated differently, ATS 110 may be configured to land at ATS landing site 30 in a vertical orientation.

As schematically illustrated in FIGS. 3-4, landing site 30 may have any appropriate proximity and/or locational relationship to launch site 20. For example, and as schematically illustrated in FIG. 3, return portion 66 of ATS trajectory 60 may be configured such that landing site 30 is at or near launch site 20. Alternatively, and as schematically illustrated in FIG. 4, return portion 66 of ATS trajectory 60 may be configured such that landing site 30 is removed from and/or distant from launch site 20. As more specific examples, and as schematically illustrated in FIGS. 3-4, launch site 20 and landing site 30 may be separated by an ATS landing radius 32 that is more than 1 km, at most 1 km, at most 500 meters, at most 100 meters, at most 50 meters, at most 10 meters, and/or at most 5 meters.

With continued reference to FIGS. 3-4, ATS 110 generally is configured to return to Earth in a controlled descent during return portion 66 of ATS trajectory 60. As used herein, the term “controlled descent” may refer to any appropriate combination of active and/or passive control means, such as may be configured to ensure and/or facilitate that ATS 110 be substantially undamaged upon returning to Earth and/or that ATS 110 lands in a vertical orientation. In this manner, ATS 110 (and/or return portion 66 of ATS trajectory 60) may be configured such that ATS 110 may be retrieved and reused subsequent to return portion 66 of ATS trajectory 60. That is, ATS 110 may be configured to be reused with a distinct second stage 200 to define a distinct launch vehicle 100 for a subsequent launch of a distinct payload 220 to a payload destination subsequent to return portion 66 of ATS trajectory 60.

Returning to FIGS. 1-2, launch vehicle 100, ATS 110, and/or second stage 200 may have any appropriate structure and/or configuration for selectively and operatively coupling ATS 110 and second stage 200. For example, and as schematically illustrated in FIGS. 1-2, structural frame 120 may define a central bore 130 (shown in FIG. 1) and second stage 200 may be coupled to ATS 110 such that second stage 200 extends through central bore 130 (as schematically illustrated in FIG. 2) during at least launch portion 52 of payload trajectory 50. As schematically illustrated in FIG. 1, central bore 130 may extend fully through structural frame 120. ATS 110 may be configured to receive second stage 200 within central bore 130 such that second stage 200 is at least substantially aligned with central bore 130. For example, and as schematically illustrated in FIG. 2, second stage 200 may have a second stage longitudinal axis 202 such that central bore 130 is aligned with second stage longitudinal axis 202. As a more specific example, structural frame 120 may define a frame central axis 122 that extends through central bore 130 such that second stage longitudinal axis 202 and frame central axis 122 are coaxial.

Central bore 130 and second stage 200 may have any appropriate relative dimensions, such as to facilitate ATS 110 securely engaging second stage 200 during payload trajectory 50. For example, and as schematically illustrated in FIG. 1, central bore 130 may have a central bore diameter 132, and second stage 200 may have a second stage diameter 204 that is smaller than central bore diameter 132. As more specific examples, a ratio of central bore diameter 132 to second stage diameter may be at least 1.05, at least 1.2, at least 1.5, at least 1.7, at most 2, at most 1.8, at most 1.6, at most 1.3, and/or at most 1.1.

As schematically illustrated in FIG. 1, launch vehicle 100 may include a second stage coupling mechanism 104 configured to selectively and operatively couple second stage 200 to ATS 110 for launch of launch vehicle 100 and configured to selectively and operatively decouple second stage 200 from ATS 110 during payload trajectory 50. Second stage coupling mechanism 104 may include and/or be any appropriate structure or collection of structures. For example, and as schematically illustrated in FIG. 1, second stage coupling mechanism 104 may include and/or be a plurality of spaced-apart structures. As examples, second stage coupling mechanism 104 may include and/or be explosive bolts and/or separation nuts. Second stage coupling mechanism 104 may be associated with any appropriate portion of launch vehicle 100. As examples, either or both of structural frame 120 and second stage 200 may include second stage coupling mechanism 104.

With continued reference to FIGS. 1-2, ATS 110 may have any appropriate structure and/or configuration for propelling launch vehicle 100 during launch portion 52 of payload trajectory 50 and/or during boost portion 62 of ATS trajectory 60. For example, ATS 110 may include any appropriate number of airbreathing engines 160, such as at least three airbreathing engines 160, at least four airbreathing engines 160, at least six airbreathing engines 160, at least eight airbreathing engines 160, at least 10 airbreathing engines 160, at least 15 airbreathing engines 160, at least 20 airbreathing engines 160, at least 25 airbreathing engines 160, at least 30 airbreathing engines 160, at least 35 airbreathing engines 160, at most 40 airbreathing engines 160, at most 32 airbreathing engines 160, at most 27 airbreathing engines 160, at most 22 airbreathing engines 160, at most 17 airbreathing engines 160, at most 12 airbreathing engines 160, at most nine airbreathing engines 160, at most seven airbreathing engines 160, and/or at most five airbreathing engines 160. As schematically illustrated in FIGS. 1-2, the plurality of airbreathing engines 160 may be at least substantially evenly distributed around structural frame 120, such as may correspond to ATS 110 being at least substantially rotationally symmetric about frame central axis 122. In general, it may be preferable that ATS 110 include at least three airbreathing engines 160 evenly distributed around structural frame 120, such as to ensure that launch vehicle 100 is aerodynamically stable when under the power of the plurality of airbreathing engines 160. Stated differently, an aerodynamic stability of launch vehicle 100 may be controlled via modulation of the thrust supplied by each of the plurality of airbreathing engines 160, such as to at least partially control an attitude of launch vehicle 100 during flight.

As used herein, the term “airbreathing engine” is intended to refer to any appropriate engine or apparatus configured to receive a flow of air from external the engine and to energize the air flow by combusting the air flow with a fuel to produce an accelerated exhaust stream, thereby generating a thrust. Accordingly, each airbreathing engine 160 may include and/or be any appropriate embodiment of an airbreathing engine, examples of which include a jet engine, a turbojet engine, a turbofan engine, a high-bypass turbofan engine, a low-bypass turbofan engine, a gas turbine engine, an afterburning jet engine, a turboprop engine, and/or a propfan engine. Additionally or alternatively, and as schematically illustrated in FIG. 2, each airbreathing engine 160 may include an air inlet 164 configured to receive an air flow and an exhaust 166 configured to expel an exhaust flow to generate thrust, such as along ATS thrust vector 162. As used herein, a thrust vector generally refers to a force vector corresponding to a force exerted by an engine, and thus is generally directed opposite an exhaust flow that produces the force.

The plurality of airbreathing engines 160 generally are configured to produce a sufficient total thrust to vertically accelerate and lift launch vehicle 100, including ATS 110 and second stage 200. Accordingly, the plurality of airbreathing engines 160 may be selected and/or configured based upon any appropriate considerations, such as a total mass of second stage 200 and/or of payload 220. As examples, the plurality of airbreathing engines 160 may be configured to produce a combined thrust during boost portion 62 of ATS trajectory 60 that is at least 500 kilonewtons (kN), at least 1,000 kN, at least 2,000 kN, at least 5,000 kN, at least 7,000 kN, and/or at most 10,000 kN. Additionally or alternatively, the plurality of airbreathing engines 160 may be configured such that ATS 110 produces a net thrust (e.g., the combined thrust minus a gross weight of ATS 110) that is at least 500 kN, at least 1,000 kN, at least 2,000 kN, at least 5,000 kN, at least 7,000 kN, and/or at most 10,000 kN.

The form and/or number of the plurality of airbreathing engines 160 may be selected according to any appropriate criteria and/or operational constraints. As an example, an embodiment of ATS 110 may include a relatively small number (e.g., between three and eight) airbreathing engines 160 in the form of high-bypass turbofan engines. In such an embodiment, a radius of each airbreathing engine 160 may be sufficiently large relative to a lateral dimension of ATS 110 (such as central bore diameter 132) that selective modulation of the relative magnitudes of ATS thrust vectors 162 may permit stable control of an attitude of launch vehicle 100. That is, as a distance between frame central axis 122 and a given ATS thrust vector 162 increases, the given ATS thrust vector 162 may correspond to a greater torque imparted upon launch vehicle 100. In this manner, utilizing airbreathing engines 160 in the form of high-bypass turbofan engines may enhance a rotational and/or attitudinal stability of launch vehicle 100 during flight. As another example, another embodiment of ATS 110 may include a relatively large number (e.g., between 15 and 35) of airbreathing engines 160 in the form of low-bypass turbofan engines. Such an embodiment may be beneficial in scenarios in which it is desirable to maximize a total thrust produced by the plurality of airbreathing engines 160 while minimizing a cross-sectional aerodynamic profile of launch vehicle 100, such as to minimize an aerodynamic drag force exerted upon launch vehicle 100 during launch portion 52 of payload trajectory 50.

Each airbreathing engine 160 generally may be configured to operate in an atmosphere with a sufficient density and/or oxygen content to sustain continuous combustion within the engine. Thus, each airbreathing engine 160 may be configured to operate at or below a maximum operating altitude above ground level. As examples, each airbreathing engine 160 may be configured to operate at or below a maximum operating altitude above ground level that is at least 5 km, at least 10 km, at least 15 km, at least 20 km, at least 25 km, at least 30 km, at least 35 km, at most 40 km, at most 32 km, at most 27 km, at most 22 km, at most 17 km, at most 12 km, and/or at most 7 km.

Each airbreathing engine 160 may be coupled to structural frame 120 in any appropriate manner. As an example, and as schematically illustrated in FIGS. 1-2, each airbreathing engine 160 may be mounted on a frame exterior surface 124 of structural frame 120, such as via a respective engine mount 170 of ATS 110. Each engine mount 170 may have any appropriate structure and/or functionality for coupling airbreathing engine 160 to structural frame 120. As an example, each engine mount 170 may be configured such that the corresponding airbreathing engine 160 may be selectively mounted to and removed from structural frame 120. In this manner, ATS 110 (e.g., a given ATS 110) may be configured to include different numbers and/or configurations of airbreathing engines 160, such as may depend upon the specifications of a given second stage 200 and/or payload 220.

With continued reference to FIGS. 1-2, ATS 110 maybe configured to store and/or deliver fuel to the plurality of airbreathing engines 160 in any appropriate manner. For example, and as schematically illustrated in FIG. 1, ATS 110 and/or structural frame 120 may include a fuel tank 140 for carrying a liquid fuel for the plurality of airbreathing engines 160. As a more specific example, fuel tank 140 may extend at least partially, and optionally fully, circumferentially around central bore 130 of structural frame 120. Additionally or alternatively, and as further schematically illustrated in FIG. 1, ATS 110 may include at least one fuel conduit 172 for carrying fuel from fuel tank 140 to each of the plurality of airbreathing engines 160. For example, each engine mount 170 may include, support, and/or enclose a corresponding fuel conduit 172.

As further schematically illustrated in FIG. 1, ATS 110 may include one or more stability struts 190 configured to enhance a structural stability of ATS 110. When present, stability struts 190 may be coupled to any appropriate components of ATS 110. As examples, and as schematically illustrated in FIG. 1, each stability strut 190 may be coupled to each of two or more airbreathing engines 160, and/or may be coupled to each of an airbreathing engine 160 and structural frame 120.

Second stage 200 may include and/or be any appropriate apparatus for delivering payload 220 to the payload destination. For example, and as schematically illustrated in FIG. 2, second stage 200 may include at least one second stage engine 210 configured to generate a thrust to transport payload 220 to the payload destination during at least second portion 54 of payload trajectory 50. Second stage engine 210 may include and/or be any appropriate engine, such as may be known to the field of aerospace engineering. For example, second stage engine 210 may be configured to be powered by a liquid fuel, examples of which include liquid oxygen, liquid hydrogen, and/or Rocket Propellant-1 (RP-1). Additionally or alternatively, second stage engine 210 may be configured to be powered by a solid fuel. In some embodiments, second stage engine 210 may include and/or be a gimbaled thrust system, such as to permit guidance of second stage 200 during second portion 54 of payload trajectory 50. It is additionally within the scope of the present disclosure that second stage 200 may include and/or encompass a plurality of stages, e.g. such that multi-stage launch system 10 includes more than two stages. In such an embodiment, for example, second stage 200 may include a plurality of distinct second stage engines 210 configured to be fired sequentially and/or in a corresponding plurality of stages.

While the present disclosure generally relates to examples in which second stage 200 is powered (e.g., that second stage 200 includes second stage engine 210), this is not required to all embodiments, and it is additionally within the scope of the present disclosure that second stage 200 may not include a propulsion source. In such embodiments, second stage 200 also may be referred to as a ballistic second stage 200.

ATS 110 may be configured to return to Earth in any appropriate manner. In general, ATS 110 is configured to regulate a speed at which ATS 110 returns to Earth, such as via any appropriate active and/or passive mechanisms. As an example, ATS 110 may be configured to utilize one or more of the plurality of airbreathing engines 160 to actively regulate a speed and/or flight path of ATS 110 during return portion 66 of ATS trajectory 60. As a more specific example, and as schematically illustrated in FIG. 3, ATS 110 may be configured to operate under the power of a landing subset of the plurality of airbreathing engines 160 during return portion 66 and/or landing portion 68. That is, modulation of the magnitude of ATS thrust vector 162 produced by each airbreathing engine 160 in the landing subset may serve to slow and/or guide ATS 110 during return portion 66. In this manner, it may be desirable that the landing subset include three or more airbreathing engines 160 of the plurality of airbreathing engines 160 that are selected and/or distributed around structural frame 120 to enable control of an attitude of ATS 110 in three dimensions. Accordingly, for example, the landing subset of the plurality of airbreathing engines 160 may be at least substantially evenly distributed around structural frame 120. It is within the scope of the present disclosure that the landing subset may include any appropriate number of airbreathing engines 160, such as three airbreathing engines 160, four airbreathing engines 160, more than four airbreathing engines 160, and/or fewer than all of the plurality of airbreathing engines 160. FIG. 3 schematically illustrates an example in which the landing subset includes three airbreathing engines 160.

In an embodiment of ATS 110 that utilizes the landing subset of the plurality of airbreathing engines 160 during return portion 66, the landing subset may be described as enabling active control of return portion 66, such as to guide ATS 110 to a predetermined landing site 30. However, and as schematically illustrated in FIGS. 1-2 and 4, it is further within the scope of the present disclosure that ATS 110 additionally or alternative may include a passive drag device 182 configured to at least partially regulate return portion 66 of ATS trajectory 60. More specifically, when present, passive drag device 182 is configured to impart a drag force on ATS 110 during at least a portion of return portion 66. In this manner, passive drag device 182 may be configured to reduce an airspeed of ATS 110, may be configured to modulate an attitude of ATS 110, and/or may be configured to at least partially guide ATS 110 toward ATS landing site 30. Passive drag device 182 may include and/or be any appropriate apparatus for increasing an aerodynamic drag force on ATS 110, examples of which include a parachute, a drogue chute, a parafoil chute, and/or an air brake.

FIG. 4 schematically illustrates an example in which passive drag device 182 includes a plurality of parachutes that deploy during return portion 66 of ATS trajectory 60. In this example, the parachutes are configured to reduce an airspeed of ATS 110 during return portion 66, as well as to utilize the drag force to position ATS 110 in a substantially vertical orientation for landing portion 68. In the example of FIG. 4, ATS 110 additionally utilizes the landing subset of the plurality of airbreathing engines 160 near the end of landing portion 68 to further slow ATS 110 for a gentle landing at landing site 30.

As further schematically illustrated in FIGS. 1-4, ATS 110 additionally may include a landing gear assembly 184 configured to support launch vehicle 100 upon a ground surface in a vertical orientation. In this manner, landing gear assembly 184 may be configured to support launch vehicle 100 upon the ground surface prior to initiating boost portion 62 of ATS trajectory 60. Additionally or alternatively, landing gear assembly 184 may be configured to permit ATS 110 to land upon the ground surface in a vertical orientation during landing portion 68 of ATS trajectory 60, and/or to support ATS 110 upon the ground surface subsequent to landing at landing site 30. Landing gear assembly 184 may include and/or be any appropriate structure. For example, and as schematically illustrated in FIGS. 1-4, landing gear assembly 184 may include and/or be a plurality of landing legs, such as may be distributed around structural frame 120. As additional examples, landing gear assembly 184 may include and/or be a landing skid, and/or may include one or more wheels configured to permit ATS 110 to travel along the ground surface. As further schematically illustrated in FIG. 1, landing gear assembly 184 (and/or each component thereof) may include a shock absorber 186 configured to at least partially absorb an impact force when ATS 110 lands upon the ground surface during landing portion 68.

The foregoing examples are intended to be illustrative of apparatuses and configurations that may be utilized during return portion 66 and/or landing portion 68 of ATS trajectory 60. However, these examples are not intended to be exhaustive of all appropriate embodiments, and it additionally is within the scope of the present disclosure that ATS 110 may return to Earth and/or be recovered in any other appropriate manner. As additional examples, ATS 110 may employ powered and/or auto-rotating rotors during return portion 66 and/or may employ air bags to absorb an impact force upon landing. Additionally or alternatively, ATS 110 may be configured to be retrieved by a distinct aircraft via an aerial capture mechanism.

With continued reference to FIGS. 1-2, ATS 110 additionally may include an attitude control device 180 configured to control an attitude and/or a spatial orientation of ATS 110 during flight. Attitude control device 180 may include and/or be any appropriate device for imparting a torque on ATS 110 during flight, examples of which include a reaction control system (RCS) thruster, a gyroscope, and/or a reaction wheel.

Multi-stage launch system 10 may be configured to control payload trajectory 50 and/or ATS trajectory 60 in any appropriate manner. For example, and as schematically illustrated in FIGS. 1-4, multi-stage launch system 10, launch vehicle 100, and/or ATS 110 may include a control system 40 configured to at least partially control ATS 110 during boost portion 62, return portion 66, and/or landing portion 68 of ATS trajectory 60. As a more specific example, control system 40 may be configured to transmit a control signal to control a thrust produced by each of the plurality of airbreathing engines 160, such as via electrical connections extending through and/or supported by each engine mount 170. As additional examples, control system 40 may be configured to actively and/or autonomously control the controlled descent of ATS 110 during return portion 66, such as by modulating a thrust produced by the landing subset of the plurality of airbreathing engines 160 and/or by selectively deploying passive drag device 182. Control system 40 may include any appropriate components to facilitate control of ATS 110. As an example, and as schematically illustrated in FIGS. 1-2, control system 40 may include an avionics system 150 positioned onboard ATS 110. Avionics system 150 may include one or more sensors and/or devices for measuring an operational state of ATS 110. As examples, avionics system 150 may include a global positioning system (GPS) receiver 152 and/or an inertial measurement unit (IMU) 154 configured to measure a position and/or a location of ATS 110 during flight. Additionally or alternatively, avionics system 150 may include one or more environmental sensors 158 configured to sense environmental conditions associated with ATS 110. In such examples, control system 40 may be configured to utilize the sensed environmental conditions to at least partially control ATS 110 during ATS trajectory 60. As a more specific example, environmental sensors 158 may be configured to sense environmental conditions during boost portion 62 of ATS trajectory 60, such as to determine when ATS 110 has reached an altitude corresponding to staging point 64. As another example, environmental sensors 158 may be configured to sense environmental conditions during return portion 66 of ATS trajectory 60, such that control system 40 is configured to utilize the sensed environmental conditions to guide ATS 110 during return portion 66.

Control system 40 additionally or alternatively may include one or more components configured to facilitate wireless communication with ATS 110. For example, and as schematically illustrated in FIGS. 1-4, avionics system 150 may include an ATS communication device 156 (schematically illustrated in FIGS. 1-2) configured to wirelessly transmit and/or receive signals, and control system 40 additionally may include a land-based communication device 42 (schematically illustrated in FIGS. 3-4) configured to wirelessly communicate with ATS communication device 156. In such an embodiment, land-based communication device 42 may be configured to selectively transmit operational commands to ATS communication device 156, such as to at least partially guide ATS 110 during boost portion 62 of ATS trajectory 60 and/or return portion 66 of ATS trajectory 60. In this manner, land-based communication device 42 may be configured to transmit operational commands to ATS communication device 156 to at least partially control the controlled descent of ATS 110.

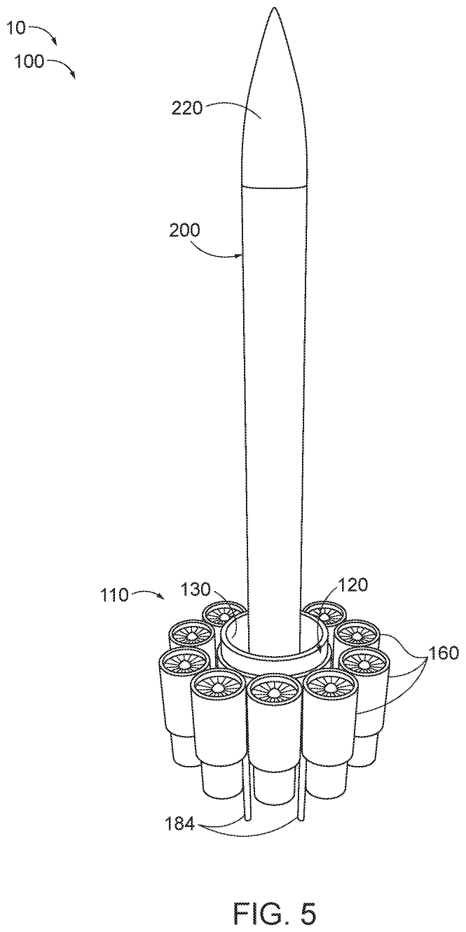

FIG. 5 is a less schematic illustration of an example of launch vehicle 100. In the example of FIG. 5, ATS 110 includes 10 airbreathing engines 160 distributed around structural frame 120, and additionally includes landing gear assembly 184 in the form of a plurality of landing legs. Second stage 200 carriers payload 220 and is received within central bore 130 of ATS 110.

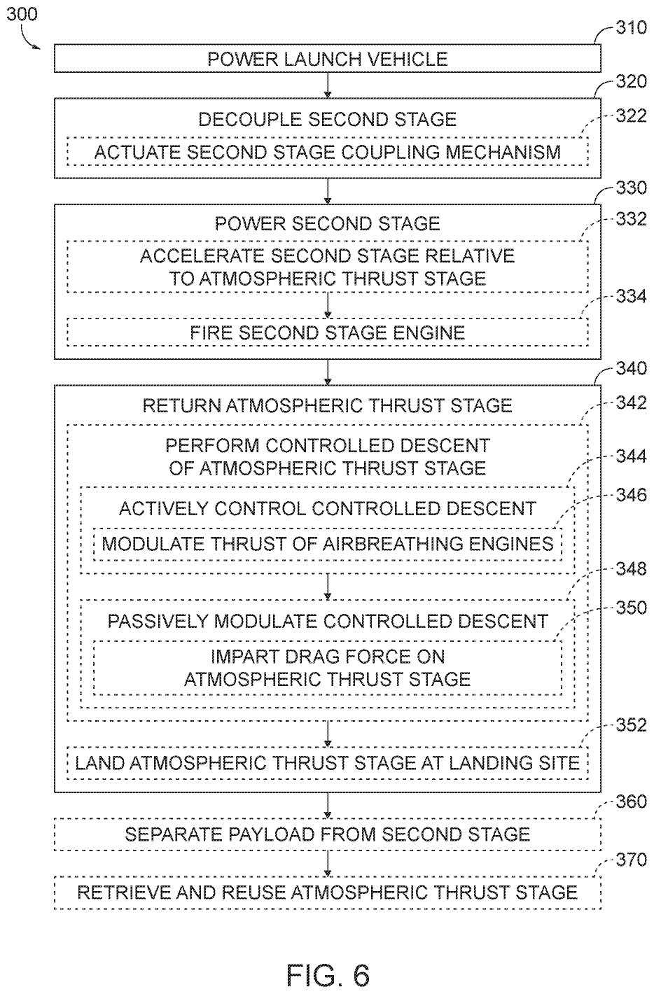

FIG. 6 is a flowchart depicting methods 300, according to the present disclosure, of transporting a payload (such as payload 220) to a payload destination. In FIG. 6, some steps are illustrated in dashed boxes indicating that such steps may be optional or may correspond to an optional version of a method according to the present disclosure. That said, not all methods according to the present disclosure are required to include the steps illustrated in solid boxes. The methods and steps illustrated in FIG. 6 are not limiting and other methods and steps are within the scope of the present disclosure, including methods having greater than or fewer than the number of steps illustrated, as understood from the discussions herein.

As shown in FIG. 6, methods 300 include powering, at 310, a launch vehicle (such as launch vehicle 100) that includes an atmospheric thrust stage (ATS) (such as ATS 110) operatively coupled to a second stage (such as second stage 200) to propel the launch vehicle through a launch portion of a payload trajectory of the payload (such as launch portion 52 of payload trajectory 50). Methods 300 additionally include decoupling, at 320, the second stage of the launch vehicle from the ATS of the launch vehicle and powering, at 330, the second stage to propel the second stage through a second portion of the payload trajectory (such as second portion 54 of payload trajectory 50) to transport the payload to the payload destination. Methods 300 further include, subsequent to the decoupling the second stage from the ATS, returning, at 340, the ATS to Earth during a return portion of an ATS trajectory of the ATS (such as return portion 66 of ATS trajectory 60). In methods 300 according to the present disclosure, the ATS includes a plurality of airbreathing engines (such as airbreathing engines 160), and the powering the launch vehicle through the launch portion at 310 includes providing thrust to the launch vehicle with the plurality of airbreathing engines.

As further shown in FIG. 6, methods 300 additionally may include separating, at 360, the payload from the second stage to deliver the payload to the payload destination. Additionally or alternatively, and as additionally shown in FIG. 6, methods 300 further may include, subsequent to the returning the ATS to earth at 340, retrieving, at 370, the ATS and reusing the ATS with a distinct second stage to define a distinct launch vehicle for a subsequent launch of a distinct payload to a payload destination. In this manner, methods 300 according to the present disclosure may be employed to utilize a single (e.g., a given) ATS in the process of delivering a plurality of distinct payloads to respective payload destinations. Stated differently, methods 300 according to the present disclosure may utilize a reusable ATS and/or may facilitate reusing the ATS multiple times.

The powering the second stage at 330 may be performed in any appropriate manner. For example, and as shown in FIG. 6, the powering the second stage at 330 may include accelerating, at 332, the second stage relative to the ATS to separate the second stage from the ATS. For example, the powering at 330 and/or the accelerating at 332 may include firing, at 334, a second stage engine (such as second stage engine 210) of the second stage to provide thrust to the second stage, thereby accelerating the second stage relative to the ATS. In such an example, the firing the second stage engine at 334 may be performed at any appropriate time relative to the decoupling the second stage at 320. For example, the firing the second stage engine at 334 may be performed prior to the decoupling the second stage from the ATS at 320, such as to facilitate the second stage exiting the ATS without colliding with the ATS. That is, firing the second stage engine prior to decoupling the second stage from the ATS may ensure that the trajectory of the second stage is under positive control (such as via the second stage engine) immediately upon decoupling the second stage from the ATS. Additionally or alternatively, the firing the second stage engine at 334 and the decoupling the second stage from the ATS at 320 may be described as being performed within a separation staging interval of one another, examples of which include at least 0.1 seconds (s), at least 0.5 s, at least 1 s, at least 2 s, at least 5 s, at most 10 s, at most 3 s, at most 0.7 s, and/or at most 0.3 s. For example, the separation staging interval may be chosen such that the thrust produced by a gimbaled thrust system of the second stage engine establishes directional control of the second stage prior to the decoupling the second stage at 320.

The decoupling the second stage from the ATS at 320 may be performed in any appropriate manner. For example, and as shown in FIG. 6, the decoupling at 320 may include actuating, at 322, a second stage coupling mechanism (such as second stage coupling mechanism 104) that selectively and operatively couples the second stage and the ATS to one another. As examples, the actuating at 322 may include detonating an explosive bolt and/or releasing a separation nut, and/or may include releasing a mechanical coupling mechanism such as a clamp.

The returning the ATS to Earth at 340 may be performed in any appropriate manner, such as to facilitate reusing the ATS subsequent to completion of the ATS trajectory. For example, and as shown in FIG. 6, the returning the ATS to Earth at 340 may include performing, at 342, a controlled descent of the ATS. In such examples, the performing the controlled descent at 342 may include controlling in any appropriate manner. As more specific examples, and as further shown in FIG. 6, the performing the controlled descent at 342 may including actively controlling, at 344, the controlled descent, and/or may include passively modulating, at 348, the controlled descent.

In an example of the performing the controlled descent at 342 that includes the actively controlling the controlled descent at 344, such active controlling may be performed in any appropriate manner. As an example, and as shown in FIG. 6, the returning the ATS to earth at 340 may include providing thrust to the ATS with a landing subset of the plurality of airbreathing engines, and the actively controlling the controlled descent at 344 may include selectively and actively modulating a thrust, at 346, produced by each airbreathing engine in the landing subset. As more specific examples, the modulating the thrust at 346 may include modulating to control a spatial orientation of the ATS, modulating to control a spatial position (e.g., a flight path) of the ATS, and/or modulating to control a velocity of the ATS. In such examples, the actively controlling at 344 may be performed at least substantially autonomously.

In an example of the performing the controlled descent at 342 that includes the passively modulating the controlled descent at 348, such passive modulation may be performed and/or achieved in any appropriate manner. For example, and as shown in FIG. 6, the passively modulating the controlled descent at 348 may include imparting a drag force, at 350, on the ATS with a passive drag device (such as passive drag device 182) of the ATS. As examples, the imparting the drag force on the ATS at 350 may include utilizing the passive drag device to modulate a velocity of the ATS, an attitude of the ATS, and/or a flight path of the ATS. As a more specific example, the imparting the drag force on the ATS may include deploying a parachute, such as to reduce a velocity of the ATS during at least a portion of the return portion of the ATS trajectory.

With continued reference to FIG. 6, the returning the ATS to Earth at 340 and/or the performing the controlled descent of the ATS at 342 may include landing, at 352, the ATS at an ATS landing site (such as ATS landing site 30). For example, the return portion of the ATS trajectory may include a landing portion (such as landing portion 68 of ATS trajectory 60), and the landing the ATS at 352 may include landing the ATS at the ATS landing site during the landing portion. The landing the ATS at 352 may include landing the ATS at any appropriate landing site, such as a site that is at or near a launch site of the launch vehicle. As more specific examples, the powering the launch vehicle through the launch portion at 310 may include launching the launch vehicle from a launch site (such as launch site 20), and the landing the ATS at 352 may include landing the ATS at a landing site that is separated from the launch site by an ATS landing radius (such as ATS landing radius 32) that is at most 1 km, at most 500 meters, at most 100 meters, at most 50 meters, at most 10 meters, and/or at most 5 meters. In such examples, the performing the controlled descent of the ATS at 342 may include guiding the ATS toward and/or to the launch site, such as by providing thrust with the landing subset of the plurality of airbreathing engines to propel the ATS toward the launch site. However, this is not required for all examples of methods 300, and it is additionally within the scope of the present disclosure that the landing site is distant from the launch site. As an example, the performing the controlled descent of the ATS at 342 may primarily include the imparting the drag force on the ATS at 350 with the drag device, such that the ATS returns to Earth along a substantially parabolic trajectory. Such an example is schematically illustrated in FIG. 4, as discussed above. In such an example, the retrieving and reusing the ATS at 370 may include, subsequent to the retrieving the ATS and prior to the reusing the ATS, transporting the ATS from the landing site to the launch site.

Illustrative, non-exclusive examples of inventive subject matter according to the present disclosure are described in the following enumerated paragraphs:

A1. A multi-stage launch system (10) for transporting a payload (220) to a payload destination, the multi-stage launch system (10) comprising:

a launch vehicle (100) configured to transport the payload (220) to the payload destination via a payload trajectory (50);

wherein the payload trajectory (50) includes a launch portion (52) and a subsequent second portion (54); wherein the launch vehicle (100) includes an atmospheric thrust stage (ATS) (110) that includes a structural frame (120) that supports a plurality of airbreathing engines (160) configured to generate a thrust to at least partially propel the launch vehicle (100) during the launch portion (52) of the payload trajectory (50); wherein the ATS (110) is configured to be utilized in conjunction with a second stage (200) of the launch vehicle (100) that is configured to transport the payload (220) to the payload destination during the second portion (54) of the payload trajectory (50); wherein each airbreathing engine (160) of the plurality of airbreathing engines (160) is configured to impart a thrust force to the ATS (110) along a respective ATS thrust vector (162) to propel the launch vehicle (100); wherein the launch vehicle (100) is configured such that the ATS (110) and the second stage (200) are selectively and operatively coupled to and decoupled from one another; and wherein the launch vehicle (100) is configured to launch vertically such that each ATS thrust vector (162) is directed vertically upward to initiate the launch portion (52) of the payload trajectory (50).

A1.1. The multi-stage launch system (10) of paragraph A1, wherein the launch vehicle (100) further includes the second stage (200).

A2. The multi-stage launch system (10) of any of paragraphs A1-A1.1, wherein the ATS (110) is configured to travel along an ATS trajectory (60) that includes a boost portion (62) and a subsequent return portion (66), wherein the boost portion (62) is concurrent with the launch portion (52) of the payload trajectory (50), and wherein the ATS (110) is configured to return to Earth in a controlled descent during the return portion (66).

A3. The multi-stage launch system (10) of paragraph A2, wherein the return portion (66) of the ATS trajectory (60) includes a landing portion (68), wherein the ATS (110) is configured to land at an ATS landing site (30) during the landing portion (68).

A4. The multi-stage launch system (10) of paragraph A3, wherein the ATS (110) is configured such that each ATS thrust vector (162) is directed at least substantially vertically upward during the landing portion (68) of the ATS trajectory (60).

A5. The multi-stage launch system (10) of any of paragraphs A1-A4, wherein the ATS (110) and the second stage (200) are configured to be selectively decoupled from one another at a staging point (64) during the payload trajectory (50).

A6. The multi-stage launch system (10) of paragraph A5, wherein the payload trajectory (50) transitioning from the launch portion (52) to the second portion (54) corresponds to the ATS (110) and the second stage (200) selectively decoupling from one another.

A7. The multi-stage launch system (10) of any of paragraphs A5-A6, wherein the staging point (64) corresponds to a point at which the payload trajectory (50) transitions from the launch portion (52) to the second portion (54).

A8. The multi-stage launch system (10) of any of paragraphs A5-A7, when dependent from paragraph A2, wherein the staging point (64) corresponds to a point at which the ATS trajectory (60) transitions from the boost portion (62) to the return portion (66).

A9. The multi-stage launch system (10) of any of paragraphs A5-A8, wherein the staging point (64) occurs at a staging altitude that is one or more of at least 5 kilometers (km), at least 10 km, at least 15 km, at least 20 km, at least 25 km, at least 30 km, at least 35 km, at most 40 km, at most 32 km, at most 27 km, at most 22 km, at most 17 km, at most 12 km, and at most 7 km.

A10. The multi-stage launch system (10) of any of paragraphs A2-A9, wherein the ATS (110) is configured to be retrieved and reused subsequent to the return portion (66) of the ATS trajectory (60).

A11. The multi-stage launch system (10) of paragraph A10, wherein the ATS (110) is configured to be reused with a distinct second stage (200) to define a distinct launch vehicle (100) for a subsequent launch of a distinct payload (220) to the payload destination subsequent to the return portion (66) of the ATS trajectory (60).

A12. The multi-stage launch system (10) of any of paragraphs A1-A11, wherein the launch vehicle (100) is configured to be launched from a launch site (20), and wherein the ATS (110) is configured to travel to and land at an/the ATS landing site (30) subsequent to the launch portion (52) of the payload trajectory (50).

A13. The multi-stage launch system (10) of paragraph A12, wherein the ATS (110) is configured to land at the ATS landing site (30) in a vertical orientation.

A14. The multi-stage launch system (10) of any of paragraphs A2-A13, wherein the ATS (110) is configured to operate under the power of a landing subset of the plurality of airbreathing engines (160) during one or both of the return portion (66) and the landing portion (68) of the ATS trajectory (60).

A15. The multi-stage launch system (10) of paragraph A14, wherein the landing subset includes one of:

(i) three airbreathing engines (160) of the plurality of airbreathing engines (160);

(ii) four airbreathing engines (160) of the plurality of airbreathing engines (160);

more than four airbreathing engines (160) of the plurality of airbreathing engines (160); and

(iv) fewer than all of the plurality of airbreathing engines (160).

A16. The multi-stage launch system (10) of paragraph A15, wherein the landing subset of the plurality of airbreathing engines (160) is at least substantially evenly distributed around the structural frame (120).

A17. The multi-stage launch system (10) of any of paragraphs A1-A16, wherein the plurality of airbreathing engines (160) includes one or more of at least three airbreathing engines (160), at least four airbreathing engines (160), at least six airbreathing engines (160), at least eight airbreathing engines (160), at least 10 airbreathing engines (160), at least 15 airbreathing engines (160), at least 20 airbreathing engines (160), at least 25 airbreathing engines (160), at least 30 airbreathing engines (160), at least 35 airbreathing engines (160), at most 40 airbreathing engines (160), at most 32 airbreathing engines (160), at most 27 airbreathing engines (160), at most 22 airbreathing engines (160), at most 17 airbreathing engines (160), at most 12 airbreathing engines (160), at most nine airbreathing engines (160), at most seven airbreathing engines (160), and at most five airbreathing engines (160).

A18. The multi-stage launch system (10) of any of paragraphs A1-A17, wherein the plurality of airbreathing engines (160) is at least substantially evenly distributed around the structural frame (120).

A19. The multi-stage launch system (10) of any of paragraphs A2-A18, wherein the plurality of airbreathing engines (160) is configured to produce a combined thrust during the boost portion (62) of the ATS trajectory (60) that is one or more of at least 500 kilonewtons (kN), at least 1,000 kN, at least 2,000 kN, at least 5,000 kN, at least 7,000 kN, and at most 10,000 kN.

A20. The multi-stage launch system (10) of any of paragraphs A2-A19, wherein the plurality of airbreathing engines (160) is configured such that the ATS (110) produces a net thrust during the boost portion (62) of the ATS trajectory (60) that is one or more of at least 500 kN, at least 1,000 kN, at least 2,000 kN, at least 5,000 kN, at least 7,000 kN, and at most 10,000 kN.

A21. The multi-stage launch system (10) of any of paragraphs A1-A20, wherein each airbreathing engine (160) is configured to operate at or below a maximum operating altitude above ground level that is one or more of at least 5 kilometers (km), at least 10 km, at least 15 km, at least 20 km, at least 25 km, at least 30 km, at least 35 km, at most 40 km, at most 32 km, at most 27 km, at most 22 km, at most 17 km, at most 12 km, and at most 7 km.

A22. The multi-stage launch system (10) of any of paragraphs A1-A21, wherein each airbreathing engine (160) includes an air inlet (164) configured to receive an air flow and an exhaust (166) configured to expel an exhaust flow to generate thrust.

A23. The multi-stage launch system (10) of any of paragraphs A1-A22, wherein each airbreathing engine (160) includes, and optionally is, one or more of a jet engine, a turbojet engine, a turbofan engine, a high-bypass turbofan engine, a low-bypass turbofan engine, a gas turbine engine, an afterburning jet engine, a turboprop engine, and a propfan engine.

A24. The multi-stage launch system (10) of any of paragraphs A1-A23, wherein the structural frame (120) defines a central bore (130), and wherein the launch vehicle (100) is configured such that the second stage (200) extends through the central bore (130) during at least the launch portion (52) of the payload trajectory (50).

A25. The multi-stage launch system (10) of paragraph A24, wherein the central bore (130) extends fully through the structural frame (120).

A26. The multi-stage launch system (10) of any of paragraphs A24-A25, when dependent from paragraph A1.1, wherein the second stage (200) has a second stage longitudinal axis (202), and wherein the central bore (130) is aligned with the second stage longitudinal axis (202).

A27. The multi-stage launch system (10) of paragraph A26, wherein the structural frame (120) defines a frame central axis (122) that extends through the central bore (130), and wherein the second stage longitudinal axis (202) and the frame central axis (122) are coaxial.

A28. The multi-stage launch system (10) of paragraph A27, wherein the ATS (110) is at least substantially rotationally symmetric about the frame central axis (122).

A29. The multi-stage launch system (10) of any of paragraphs A24-A28, when dependent from paragraph A1.1, wherein the central bore (130) has a central bore diameter (132), and wherein the second stage (200) has a second stage diameter (204) that is smaller than the central bore diameter (132).

A30. The multi-stage launch system (10) of paragraph A29, wherein a ratio of the central bore diameter (132) to the second stage diameter (204) is one or more of at least 1.05, at least 1.2, at least 1.5, at least 1.7, at most 2, at most 1.8, at most 1.6, at most 1.3, and at most 1.1.

A31. The multi-stage launch system (10) of any of paragraphs A1-A30, wherein each airbreathing engine (160) of the plurality of airbreathing engines (160) is mounted on a frame exterior surface (124) of the structural frame (120).

A32. The multi-stage launch system (10) of any of paragraphs A1-A31, wherein the ATS (110) further includes a plurality of engine mounts (170), and wherein each airbreathing engine (160) of the plurality of airbreathing engines (160) is mounted to the structural frame (120) via a respective engine mount (170) of the plurality of engine mounts (170).

A33. The multi-stage launch system (10) of paragraph A32, wherein each engine mount (170) is configured such that the plurality of airbreathing engines (160) may be selectively mounted to and removed from the structural frame (120).

A34. The multi-stage launch system (10) of any of paragraphs A1-A33, wherein the ATS (110) further includes a fuel tank (140) for carrying a liquid fuel for the plurality of airbreathing engines (160).

A35. The multi-stage launch system (10) of paragraph A34, wherein the structural frame (120) includes the fuel tank (140).

A36. The multi-stage launch system (10) of any of paragraphs A34-A35, wherein the fuel tank (140) extends at least partially, and optionally fully, circumferentially around a/the central bore (130) of the structural frame (120).

A37. The multi-stage launch system (10) of any of paragraphs A34-A36, wherein the ATS (110) further includes at least one fuel conduit (172) for carrying fuel from the fuel tank (140) to the plurality of airbreathing engines (160).

A38. The multi-stage launch system (10) of paragraph A37, wherein each engine mount (170) includes a corresponding fuel conduit (172).

A39. The multi-stage launch system (10) of any of paragraphs A1-A38, wherein the ATS (110) further includes one or more stability struts (190) configured to enhance a structural stability of the ATS (110).

A40. The multi-stage launch system (10) of paragraph A39, wherein each stability strut (190) is coupled to each of:

(i) an airbreathing engine (160) of the plurality of airbreathing engines (160); and

(ii) one or more of:
(a) at least one other airbreathing engine (160) of the plurality of airbreathing engines (160); and
(b) the structural frame (120).

A41. The multi-stage launch system (10) of any of paragraphs A1-A40, wherein the launch vehicle (100) includes a second stage coupling mechanism (104) configured to selectively and operatively couple the second stage (200) to the ATS (110) for launch of the launch vehicle (100), and wherein the second stage coupling mechanism (104) further is configured to selectively and operatively decouple the second stage (200) from the ATS (110) during the payload trajectory (50).

A42. The multi-stage launch system (10) of paragraph A41, wherein one or both of a/the second stage (200) and the structural frame (120) includes the second stage coupling mechanism (104).

A43. The multi-stage launch system (10) of any of paragraphs A41-A42, wherein the second stage coupling mechanism (104) includes one or more of explosive bolts and separation nuts.

A44. The multi-stage launch system (10) of any of paragraphs A2-A43, wherein the ATS (110) further includes a passive drag device (182) configured to impart a drag force on the ATS (110) during at least a portion of the return portion (66) of the ATS trajectory (60).

A45. The multi-stage launch system (10) of paragraph A44, wherein the passive drag device (182) includes one or more of a parachute, a drogue chute, a parafoil chute, and an air brake.

A46. The multi-stage launch system (10) of any of paragraphs A44-A45, wherein the passive drag device (182) is configured to reduce an airspeed of the ATS (110).

A47. The multi-stage launch system (10) of any of paragraphs A44-A46, wherein the passive drag device (182) is configured to modulate an attitude of the ATS (110).

A48. The multi-stage launch system (10) of any of paragraphs A44-A47, wherein the passive drag device (182) is configured to at least partially guide the ATS (110) toward a/the ATS landing site (30).

A49. The multi-stage launch system (10) of any of paragraphs A2-A48, wherein the ATS (110) further includes a landing gear assembly (184) configured to support the launch vehicle (100) upon a ground surface in a vertical orientation prior to initiating the boost portion (62) of the ATS trajectory (60).

A50. The multi-stage launch system (10) of paragraph A49, wherein the landing gear assembly (184) further is configured to permit the ATS (110) to land upon the ground surface in a vertical orientation during a/the landing portion (68) of the ATS trajectory (60).

A51. The multi-stage launch system (10) of any of paragraphs A49-A50, wherein the landing gear assembly (184) further is configured to support the ATS (110) upon the ground surface in a vertical orientation subsequent to the ATS (110) landing at a/the landing site (30).

A52. The multi-stage launch system (10) of any of paragraphs A49-A51, wherein the landing gear assembly (184) includes a plurality of landing legs.

A53. The multi-stage launch system (10) of any of paragraphs A49-A52, wherein the landing gear assembly (184) includes a landing skid.

A54. The multi-stage launch system (10) of any of paragraphs A49-A53, wherein the landing gear assembly (184) includes one or more wheels configured to permit the ATS (110) to travel along the ground surface.

A55. The multi-stage launch system (10) of any of paragraphs A49-A54, wherein the landing gear assembly (184) includes a shock absorber (186) configured to at least partially absorb an impact force when the ATS (110) lands upon the ground surface.

A56. The multi-stage launch system (10) of any of paragraphs A2-A55, further comprising: a control system (40) configured to at least partially control the ATS (110) during one or more of the boost portion (62), the return portion (66), and the landing portion (68) of the ATS trajectory (60).

A57. The multi-stage launch system (10) of paragraph A56, wherein the control system (40) includes an avionics system (150) positioned onboard the ATS (110).

A58. The multi-stage launch system (10) of paragraph A57, wherein the avionics system (150) includes a global positioning system (GPS) receiver (152).

A59. The multi-stage launch system (10) of any of paragraphs A57-A58, wherein the avionics system (150) includes an inertial measurement unit (IMU) (154).

A60. The multi-stage launch system (10) of any of paragraphs A57-A59, wherein the avionics system (150) includes an ATS communication device (156) configured to wirelessly transmit and/or receive signals.

A61. The multi-stage launch system (10) of any of paragraphs A57-A60, wherein the avionics system (150) includes one or more environmental sensors (158) configured to sense environmental conditions associated with the ATS (110) during one or more of the boost portion (62) of the ATS trajectory (60) and the return portion (66) of the ATS trajectory (60), and wherein the control system (40) is configured to utilize the sensed environmental conditions to at least partially control the ATS (110) during the ATS trajectory (60).

A62. The multi-stage launch system (10) of any of paragraphs A56-A61, wherein the control system (40) is configured to autonomously control the controlled descent.

A63. The multi-stage launch system (10) of any of paragraphs A56-A62, wherein the control system (40) is configured to actively control the controlled descent.

A64. The multi-stage launch system (10) of any of paragraphs A56-A63, wherein the control system (40) includes a land-based communication device (42) and an/the ATS communication device (156), and wherein the land-based communication device (42) is configured to selectively transmit operational commands to the ATS communication device (156) to at least partially control the ATS (110) during one or more of the boost portion (62) of the ATS trajectory (60) and the return portion (66) of the ATS trajectory (60).

A65. The multi-stage launch system (10) of any of paragraphs A56-A64, wherein the control system (40) includes an attitude control device (180) onboard the ATS (110) configured to control a spatial orientation of the ATS (110).

A66. The multi-stage launch system (10) of paragraph A65, wherein the attitude control device (180) includes one or more of a reaction control system (RCS) thruster, a gyroscope, and a reaction wheel.

A67. The multi-stage launch system (10) of any of paragraphs A1-A66, when dependent from paragraph A1.1, wherein the second stage (200) includes at least one second stage engine (210) configured to generate a thrust to transport the payload (220) to the payload destination during at least a/the second portion (54) of a/the payload trajectory (50).

A68. The multi-stage launch system (10) of paragraph A67, wherein the second stage engine (210) is configured to be powered by a liquid fuel.

A69. The multi-stage launch system (10) of paragraph A68, wherein the liquid fuel includes one or more of liquid oxygen, liquid hydrogen, and Rocket Propellant-1 (RP-1).

A70. The multi-stage launch system (10) of any of paragraphs A68-A69, wherein the second stage engine (210) is configured to be powered by a solid fuel.

A71. The multi-stage launch system (10) of any of paragraphs A67-A70, wherein the second stage engine includes a gimbaled thrust system.

A72. The multi-stage launch system (10) of any of paragraphs A67-A71, wherein the at least one second stage engine (210) includes a plurality of second stage engines (210) configured to be fired sequentially.

A73. The multi-stage launch system (10) of any of paragraphs A1-A72, wherein the payload destination includes one or more of outer space, a sub-orbital trajectory, an Earth-centered orbit, a low-Earth orbit, a medium Earth orbit, a geosynchronous orbit, and a high Earth orbit.

B1. The use of the multi-stage launch system (10) of any of paragraphs A1-A73 to deliver a payload (220) to a payload destination.

C1. A method of transporting a payload (220) to a payload destination, the method comprising:

powering a launch vehicle (100) that includes an atmospheric thrust stage (ATS) (110) operatively coupled to a second stage (200) to propel the launch vehicle (100) through a launch portion (52) of a payload trajectory (50) of the payload (220);

decoupling the second stage (200) of the launch vehicle (100) from the ATS (110) of the launch vehicle (100);

powering the second stage (200) to propel the second stage (200) through a second portion (54) of the payload trajectory (50) to transport the payload (220) to the payload destination; and

subsequent to the decoupling the second stage (200) from the ATS (110), returning the ATS (110) to Earth during a return portion (66) of an ATS trajectory (60) of the ATS (110);

wherein the ATS (110) includes a plurality of airbreathing engines (160); and wherein the powering the launch vehicle (100) through the launch portion (52) includes providing a thrust to the launch vehicle (100) with the plurality of airbreathing engines (160).

C2. The method of paragraph C1, further comprising:

separating the payload (220) from the second stage (200) to deliver the payload (220) to the payload destination.

C3. The method of any of paragraphs C1-C2, further comprising:

subsequent to the returning the ATS (110) to Earth, retrieving and reusing the ATS (110) with a distinct second stage (200) to define a distinct launch vehicle (100) for a subsequent launch of a distinct payload (220) to a payload destination.

C4. The method of any of paragraphs C1-C3, wherein the powering the second stage (200) includes accelerating the second stage (200) relative to the ATS (110) to separate the second stage (200) from the ATS (110).

C5. The method of any of paragraphs C1-C4, wherein the powering the second stage (200) includes firing a second stage engine (210) of the second stage (200) to provide thrust to the second stage (200).

C6. The method of paragraph C5, wherein the firing the second stage engine (210) is performed prior to the decoupling the second stage (200) from the ATS (110).

C7. The method of any of paragraphs C5-C6, wherein the firing the second stage engine (210) and the decoupling the second stage (200) from the ATS (110) are performed within a separation staging interval of one another, wherein the separation staging interval is one or more of at least 0.1 seconds (s), at least 0.5 s, at least 1 s, at least 2 s, at least 5 s, at most 10 s, at most 3 s, at most 0.7 s, and at most 0.3 s.

C8. The method of any of paragraphs C1-C7, wherein the decoupling the second stage (200) from the ATS (110) includes actuating a second stage coupling mechanism (104) that selectively and operatively couples the second stage (200) and the ATS (110) to one another.

C9. The method of any of paragraphs C1-C8, wherein the returning the ATS (110) to Earth includes performing a controlled descent of the ATS (110).

C10. The method of paragraph C9, wherein the performing the controlled descent includes actively controlling the controlled descent.

C11. The method of paragraph C10, wherein the actively controlling the controlled descent is performed at least substantially autonomously.

C12. The method of any of paragraphs C10-C11, wherein the returning the ATS (110) to Earth includes providing thrust to the ATS (110) with a landing subset of the plurality of airbreathing engines (160), and wherein the actively controlling the controlled descent includes selectively and actively modulating a thrust produced by each airbreathing engine (160) in the landing subset of airbreathing engines (160).

C13. The method of paragraph C12, wherein the modulating the thrust includes modulating to control a spatial orientation of the ATS (110).

C14. The method of any of paragraphs C12-C13, wherein the modulating the thrust includes modulating to control a spatial position of the ATS (110).

C15. The method of any of paragraphs C12-C14, wherein the modulating the thrust includes modulating to control a velocity of the ATS (110).

C16. The method of any of paragraphs C9-C15, wherein the performing the controlled descent includes passively modulating the controlled descent.

C17. The method of paragraph C16, wherein the passively modulating the controlled descent includes imparting a drag force on the ATS (110) with a passive drag device (182) of the ATS (110).

C18. The method of paragraph C17, wherein the imparting the drag force on the ATS (110) includes utilizing the passive drag device (182) to modulate one or more of a velocity of the ATS (110), an attitude of the ATS (110), and a flight path of the ATS (110).

C19. The method of any of paragraphs C17-C18, wherein the imparting the drag force on the ATS (110) includes deploying a parachute.

C20. The method of any of paragraphs C1-C19, wherein the return portion (66) of the ATS trajectory (60) includes a landing portion (68), and wherein the returning the ATS (110) to Earth further includes landing the ATS (110) at an ATS landing site (30) during the landing portion (68).

C21. The method of paragraph C20, wherein the powering the launch vehicle (100) through the launch portion (52) includes launching the launch vehicle (100) from a launch site (20), wherein the ATS landing site (30) and the launch site (20) are separated by an ATS landing radius (32), and wherein the ATS landing radius (32) is one or more of more than 1 km, at most 1 km, at most 500 meters, at most 100 meters, at most 50 meters, at most 10 meters, and at most 5 meters.

C22. The method of any of paragraphs C1-C21, wherein the payload destination includes one or more of outer space, a sub-orbital trajectory, an Earth-centered orbit, a low-Earth orbit, a medium Earth orbit, a geosynchronous orbit, and a high Earth orbit.

C23. The method of any of paragraphs C1-C22, utilizing the multi-stage launch system (10) of any of paragraphs A1-A73.

As used herein, the phrase “at least substantially,” when modifying a degree or relationship, includes not only the recited “substantial” degree or relationship, but also the full extent of the recited degree or relationship. A substantial amount of a recited degree or relationship may include at least 75% of the recited degree or relationship. For example, a first direction that is at least substantially parallel to a second direction includes a first direction that is within an angular deviation of 22.5° relative to the second direction and also includes a first direction that is identical to the second direction.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order, concurrently, and/or repeatedly. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

The various disclosed elements of apparatuses and systems and steps of methods disclosed herein are not required to all apparatuses, systems, and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus, system, or method. Accordingly, such inventive subject matter is not required to be associated with the specific apparatuses, systems, and methods that are expressly disclosed herein and such inventive subject matter may find utility in apparatuses, systems, and/or methods that are not expressly disclosed herein.

1. A multi-stage launch system for transporting a payload to a payload destination, the multi-stage launch system comprising:
a launch vehicle configured to transport the payload to the payload destination via a payload trajectory;
wherein the payload trajectory includes a launch portion and a subsequent second portion; wherein the launch vehicle includes an atmospheric thrust stage (ATS) that includes a structural frame that supports a plurality of airbreathing engines configured to generate a thrust to at least partially propel the launch vehicle during the launch portion of the payload trajectory; wherein the ATS is configured to be utilized in conjunction with a second stage of the launch vehicle that is configured to transport the payload to the payload destination during the second portion of the payload trajectory; wherein each airbreathing engine of the plurality of airbreathing engines is configured to impart a thrust force to the ATS along a respective ATS thrust vector to propel the launch vehicle; wherein the launch vehicle is configured such that the ATS and the second stage are selectively and operatively coupled to and decoupled from one another; wherein the ATS is configured to travel along an ATS trajectory that includes a boost portion and a subsequent return portion; wherein the boost portion is concurrent with the launch portion of the payload trajectory; wherein the launch vehicle is configured to launch vertically such that each ATS thrust vector is directed vertically upward to initiate the launch portion of the payload trajectory; wherein the ATS is configured to return to Earth in a controlled descent during the return portion; and wherein the ATS is configured to be retrieved and reused subsequent to the return portion of the ATS trajectory.

2. The multi-stage launch system of claim 1, wherein the plurality of airbreathing engines includes at least three airbreathing engines and at most 40 airbreathing engines.

3. The multi-stage launch system of claim 1, wherein each airbreathing engine of the plurality of airbreathing engines is one or more of a jet engine, a turbojet engine, a turbofan engine, a high-bypass turbofan engine, a low-bypass turbofan engine, a gas turbine engine, an afterburning jet engine, a turboprop engine, and a propfan engine.

4. The multi-stage launch system of claim 1, wherein the ATS and the second stage are configured to be selectively decoupled from one another during the payload trajectory.

5. The multi-stage launch system of claim 1, wherein the return portion of the ATS trajectory includes a landing portion; wherein the ATS is configured to land at an ATS landing site during the landing portion; and wherein the ATS is configured to land at the ATS landing site in a vertical orientation.

6. The multi-stage launch system of claim 5, wherein the ATS is configured to operate under power of a landing subset of the plurality of airbreathing engines during the return portion of the ATS trajectory, wherein the landing subset of the plurality of airbreathing engines includes fewer airbreathing engines than all of the plurality of airbreathing engines.

7. The multi-stage launch system of claim 1, wherein the structural frame defines a central bore that extends fully through the structural frame, and wherein the launch vehicle is configured such that the second stage extends through the central bore during at least the launch portion of the payload trajectory.

8. The multi-stage launch system of claim 1, wherein the ATS further includes a landing gear assembly configured to support the launch vehicle upon a ground surface in a vertical orientation prior to initiating the boost portion of the ATS trajectory; wherein the landing gear assembly further is configured to permit the ATS to land upon the ground surface in a vertical orientation during a landing portion of the ATS trajectory.

9. The multi-stage launch system of claim 1, wherein the plurality of airbreathing engines are configured to produce a combined thrust during the boost portion of the ATS trajectory that is at least 500 kilonewtons (kN).

10. The multi-stage launch system of claim 1, wherein the launch vehicle further includes the second stage, wherein the second stage includes at least one second stage engine configured to generate a thrust to transport the payload to the payload destination.

11. A method of transporting a payload to a payload destination, the method comprising:
powering a launch vehicle that includes an atmospheric thrust stage (ATS) operatively coupled to a second stage to propel the launch vehicle through a launch portion of a payload trajectory of the payload;
decoupling the second stage of the launch vehicle from the ATS of the launch vehicle;
powering the second stage to propel the second stage through a second portion of the payload trajectory to transport the payload to the payload destination; and
subsequent to the decoupling the second stage from the ATS, returning the ATS to Earth during a return portion of an ATS trajectory of the ATS;
wherein the ATS includes a plurality of airbreathing engines; and wherein the powering the launch vehicle through the launch portion includes providing a thrust to the launch vehicle with the plurality of airbreathing engines.

12. The method of claim 11, wherein the powering the second stage includes accelerating the second stage relative to the ATS to separate the second stage from the ATS.

13. The method of claim 11, wherein the powering the second stage includes firing a second stage engine of the second stage to provide a thrust to the second stage, and wherein the firing the second stage engine is performed prior to the decoupling the second stage from the ATS.

14. The method of claim 13, wherein the firing the second stage engine and the decoupling the second stage from the ATS are performed within a separation staging interval of one another, wherein the separation staging interval is at most 10 seconds.

15. The method of claim 11, wherein the decoupling the second stage from the ATS includes actuating a second stage coupling mechanism that selectively and operatively couples the second stage and the ATS to one another.

16. The method of claim 11, wherein the ATS trajectory further includes a boost portion that is concurrent with the launch portion of the payload trajectory; wherein the ATS trajectory transitions from the boost portion to the return portion at a staging point that is at least substantially concurrent with the decoupling the second stage from the ATS; and wherein the staging point occurs at a staging altitude that is at least 10 kilometers (km).

17. The method of claim 11, wherein the returning the ATS to Earth includes performing a controlled descent of the ATS by providing a thrust to the ATS with a landing subset of the plurality of airbreathing engines wherein the performing the controlled descent includes selectively and actively modulating a thrust produced by each airbreathing engine in the landing subset of airbreathing engines.

18. The method of claim 17, wherein the modulating the thrust includes modulating to control a spatial orientation of the ATS.

19. The method of claim 11, wherein the return portion of the ATS trajectory includes a landing portion; wherein the returning the ATS to Earth further includes landing the ATS at an ATS landing site during the landing portion; wherein the powering the launch vehicle through the launch portion includes launching the launch vehicle from a launch site; and wherein the ATS landing site and the launch site are separated by an ATS landing radius that is at most 1 km.

20. The method of claim 11, further comprising:
subsequent to the returning the ATS to Earth, retrieving and reusing the ATS with a distinct second stage to define a distinct launch vehicle for a subsequent launch of a distinct payload to a payload destination.
